(19) United States
(12) Patent Application Publication
(10) Pub. No.: US 2010/0139162 A1
(43) Pub. Date: Jun. 10, 2010

(54) FLORAL PACKAGING MATERIAL HAVING GREAT MASTERS PRINTS THEREON

(76) Inventor: Donald E. Weder, Highland, IL (US)

Correspondence Address: DUNLAP CODDING, P.C., PO BOX 16370, OKLAHOMA CITY, OK, 73113, US

(21) Appl. No.: 12/708,338

(22) Filed: Feb. 18, 2010

Related U.S. Application Data
(63) Continuation of application No. 11/541,981, filed on Oct. 2, 2006, now abandoned.
Application No. 11/541,981 is a continuation of application No. 11/132,793, filed on May 19, 2005, now abandoned.
Application No. 11/132,793 is a division of application No. 10/706,666, filed on Nov. 12, 2003, now abandoned.
Application No. 10/706,666 is a continuation-in-part of application No. 10/266,192, filed on Oct. 4, 2002, now Pat. No. 6,691,457.
Application No. 10/266,192 is a continuation of application No. 09/643,482, filed on Aug. 22, 2000, now Pat. No. 6,510,650.
Application No. 11/132,793 is a continuation-in-part of application No. 10/633,173, filed on Aug. 1, 2003, now abandoned.
Application No. 10/633,173 is a continuation of application No. 10/247,257, filed on Sep. 16, 2002, now Pat. No. 6,618,990.
Application No. 10/247,257 is a continuation of application No. 09/969,053, filed on Oct. 2, 2001, now Pat. No. 6,474,020.
Application No. 09/969,053 is a continuation of application No. 09/732,375, filed on Dec. 7, 2000, now Pat. No. 6,324,786.
Application No. 09/732,375 is a continuation of application No. 09/559,449, filed on Apr. 27, 2000, now Pat. No. 6,240,675.
Application No. 09/559,449 is a continuation of application No. 08/787,182, filed on Jan. 21, 1997, now abandoned.
Application No. 08/787,182 is a continuation of application No. 08/482,351, filed on Jun. 7, 1995, now Pat. No. 5,706,605.

(51) Int. Cl. A01G 9/02

(52) U.S. Cl. 47/66.7

(57) ABSTRACT

An apparatus and method are disclosed for forming a decorative covering about a flower pot or a floral grouping, wherein the decorative covering has a graphic image that is prominently displayed on a selected portion of the decorative covering. The graphic image may be a masterpiece of art produced by one of the Great Masters of the Renaissance, at least a portion of a musical score, or combinations thereof.

### CROSS-REFERENCE TO RELATED APPLICATIONS

This application is a continuation of U.S. Ser. No. 11/541,981, filed Oct. 2, 2006, now abandoned; which is a continuation of U.S. Ser. No. 11/132,793, filed May 19, 2005, now abandoned; which is a divisional of U.S. Ser. No. 10/706,666, filed Nov. 12, 2003, now abandoned; which is a continuation-in-part of U.S. Ser. No. 10/266,192, filed Oct. 4, 2002, now U.S. Pat. No. 6,691,457, issued Feb. 17, 2004; which is a continuation of U.S. Ser. No. 09/643,482, filed Aug. 22, 2000, now U.S. Pat. No. 6,510,650, issued Jan. 28, 2003, the contents of each of which are hereby expressly incorporated herein by reference in their entirety.

Said application U.S. Ser. No. 11/132,793 is also a continuation-in-part of U.S. Ser. No. 10/633,173, filed Aug. 1, 2003, now abandoned; which is a continuation of U.S. Ser. No. 10/247,257, filed Sep. 13, 2002, now U.S. Pat. No. 6,618,990, issued Sep. 16, 2003; which is a continuation of U.S. Ser. No. 09/969,053, filed Oct. 2, 2001, now U.S. Pat. No. 6,474,020, issued Nov. 5, 2002; which is a continuation of U.S. Ser. No. 09/732,375, filed Dec. 7, 2000, now U.S. Pat. No. 6,324,786, issued Dec. 4, 2001; which is a continuation of U.S. Ser. No. 09/559,449, filed Apr. 27, 2000, now U.S. Pat. No. 6,240,675, issued Jun. 5, 2001; which is a continuation of U.S. Ser. No. 08/787,182, filed Jan. 20, 1997, now abandoned; which is a continuation of U.S. Ser. No. 08/482,351, filed Jun. 7, 1995, now U.S. Pat. No. 5,706,605, issued Jan. 13, 1998, the contents of which are hereby expressly incorporated herein by reference in their entirety.

### STATEMENT REGARDING FEDERALLY SPONSORED RESEARCH OR DEVELOPMENT

Not Applicable.

### FIELD OF THE INVENTION

The present invention relates generally to the field of packaging materials, and more particularly but not by way of limitation, to a decorative packaging material for floral groupings or flower pots.

### SUMMARY OF THE INVENTION

The present invention provides methods for decoratively covering floral groupings and flower pots. In one embodiment of the present invention, a sheet of material is provided that is suitable for packaging the floral grouping or flower pot, the sheet of material being provided with a graphic image such as a masterpiece work of art or a musical score disposed thereon. The sheet of material, which may be provided as a plurality of sheets in the form of a pad or roll, is sold and delivered to a customer for use by the customer in wrapping or forming the sheet of material about the floral grouping or flower pot to provide a decorative covering for the floral grouping or flower pot wherein the graphic image is conspicuously displayed on the decorative covering in order to enhance the decor of the floral grouping or flower pot. By selecting a particular graphic image, such as a particular masterpiece work of art or a particular musical score that is personally esteemed by the giver or the recipient, then the decorative covering conspicuously bearing such graphic image can lend transcendent meaning and thereby enhance the value of the floral grouping or potted plant when given as a gift or used as a decoration.

The present invention also encompasses providing decorative coverings for flower pots or floral groupings using a rigid or semi-rigid sleeve in which the flower pot or floral grouping may be disposed. The rigid or semi-rigid sleeve is provided with a graphic image as described herein above disposed thereon.

The present invention also encompasses the combination of a decorative covering for a floral grouping or flower pot with a second item, wherein both the decorative covering and the item are both provided with a graphic image as described above disposed thereon. The item may be a floral card, a floral insert, at least one balloon, a gift card, an occasion card, a candy wrapper, a bag or other container of candy, a stuffed animal, a small gift container, instructional or advertising material, and the like.

These and other advantages and features of the present invention will be apparent to one of ordinary skill in the art from the following description when read in conjunction with the drawings and appended claims.

### BRIEF DESCRIPTION OF THE DRAWINGS

FIG. 1 is a pictorial plan view representing a sheet of material having a graphic illustration of a masterpiece work of art constructed in accordance with the present invention.

FIG. 2 is a cross-sectional view of the sheet of material of FIG. 1 taken along line 2-2.

FIG. 3 is a pictorial plan view representing a sheet of material similar to the sheet of material of FIG. 1 but having an alternative graphic illustration of a musical score.

FIG. 4 is a perspective representation of a sheet of material disposed upon a support surface, the sheet of material having a graphic illustration of a masterpiece work of art thereon and having a bonding material disposed along one edge thereof, one corner of the sheet of material being upwardly turned to show a portion of a lower surface of the sheet of material.

FIG. 5 is a perspective representation of a floral grouping disposed on the sheet of material of FIG. 4.

FIG. 6 is a perspective representation of the floral grouping of FIG. 5 being wrapped with the sheet of material of FIG. 4 by one method of wrapping the sheet of material about the floral grouping.

FIG. 7 is a perspective representation of a decorative cover for a floral grouping formed of the sheet of material of FIG. 4 wherein the decorative cover has a conical configuration.

FIG. 8 is a perspective representation of a decorative cover for a floral grouping formed of the sheet of material of FIG. 4 wherein the decorative cover has a cylindrical configuration.

FIG. 9 is a perspective representation of a floral sleeve provided with a graphic illustration of a masterpiece work of art thereon in accordance with the present invention.

FIG. 10 is a perspective representation of the floral sleeve of FIG. 10 disposed about a floral grouping.

FIG. 11 is a perspective representation of a floral sleeve having a cinching member wherein the floral sleeve is provided with a graphic illustration of a masterpiece work of art thereon.

FIG. 12 is a perspective representation of the floral sleeve of FIG. 11 disposed about a floral grouping.

FIG. 13 is a perspective representation of a pad containing a plurality of sheets of material, wherein each of the sheets of material has a graphic illustration of a masterpiece work of art thereon.

FIGS. 14-16 are perspective representations illustrating sequential steps of a method of wrapping a sheet of material of the pad of FIG. 13 about a flower pot having a floral grouping disposed therein.

FIG. 17 is a perspective representation of a pad containing a plurality of sheets of material, wherein each of the sheets of material has a graphic illustration of a masterpiece work of art and a strip of bonding material thereon.

FIGS. 18-20 are perspective representations illustrating sequential steps of a method of wrapping a sheet of material of the pad of FIG. 17 about a flower pot having a floral grouping disposed therein.

FIG. 21 is an elevational representation of a floral sleeve having a detachable upper portion wherein the sleeve is provided with a graphic illustration of a masterpiece work of art thereon.

FIG. 22 is a perspective representation of the floral sleeve of FIG. 21 having a flower pot containing a floral grouping disposed therein.

FIG. 23 is perspective representation of a flower pot disposed in the floral sleeve of FIG. 21 wherein the upper portion of the floral sleeve has been removed to provide a decorative covering having a skirt portion extending decoratively about a portion of the floral grouping.

FIG. 24 is a perspective representation of a preformed pot cover formed from a sheet of material having a graphic illustration of a masterpiece work of art thereon.

FIG. 25 is a perspective representation of the preformed pot cover of FIG. 24 having a flower pot containing a floral grouping disposed therein.

FIG. 26 is a perspective representation of a preformed pot cover formed from a sheet of material having a graphic illustration of a musical score thereon.

FIG. 27 is a pictorial plan view representing a sheet of material having a graphic illustration of a musical score constructed in accordance with the present invention.

FIG. 28 is a perspective representation of a flower pot cover constructed in accordance with the present invention and having a graphic illustration of a masterpiece work of art thereon.

FIG. 29 is a perspective representation of a flower pot cover constructed in accordance with the present invention and having a graphic illustration of a masterpiece work of art thereon, the flower pot cover having a skirt.

FIG. 30 is a perspective representation of a flower pot cover constructed in accordance with the present invention and having a graphic illustration of a masterpiece work of art thereon, the flower pot cover having a skirt and an upper sleeve portion.

FIG. 31 is a perspective representation of a wrapper for a floral grouping having a floral grouping and a floral insert or floral card disposed therein.

FIG. 32 is a perspective representation of a sleeve for a floral grouping having a floral grouping and a balloon maintained in close proximity thereto.

FIG. 33 is a perspective representation of a decorative cover for a flower pot having a flower pot and a floral insert or floral card disposed therein.

FIG. 34 is a perspective representation of a sleeve for a flower pot having a flower pot and a floral insert or floral card disposed therein.

### DETAILED DESCRIPTION OF THE INVENTION

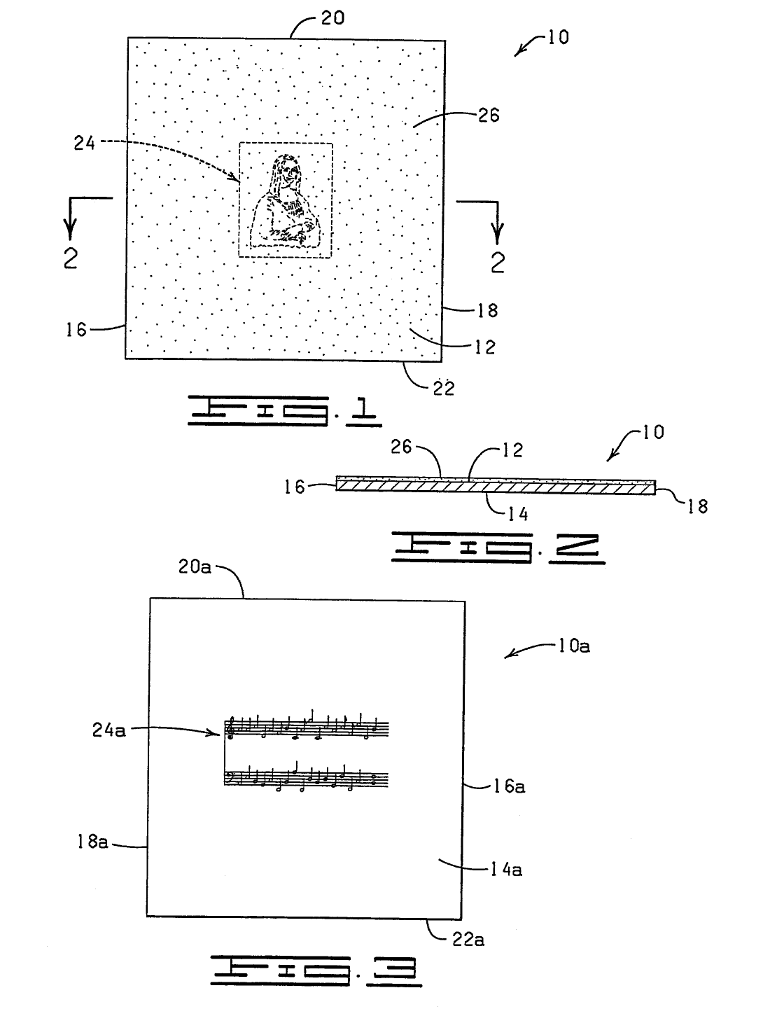

### Description of FIGS. 1-3

Referring now to the drawings, shown in FIGS. 1 and 2 is a sheet of material 10 having an upper surface 12, a lower surface 14, a first side 16, a second side 18, a first end 20, and a second end 22. The sheet of material 10 is generally square or rectangular shaped; however, the sheet of material 10 could be circularly shaped or have any other configuration desired in a particular application.

The sheet of material 10 is a relatively thin sheet of flexible, foldable material. The thickness of the sheet of material 10 may vary as long as the sheet of material 10 retains sufficient flexibility and foldability so that the sheet of material 10 can be easily formed into a decorative covering for a floral grouping, a decorative covering for a flower pot, or a sleeve which can be disposed about a floral grouping or a flower pot. Desirably, however, the sheet of material 10 is provided with a thickness in a range of from about 0.1 mil to about 30 mil. The sheet of material 10 can be constructed of any suitable material such as paper, foil, polymeric film, metallized film, cloth, laminates thereof and combinations thereof.

The term “polymeric film” as used herein includes synthetic materials such as polypropylene, and naturally occurring materials such as cellophane. A polymeric film is relatively strong and not as readily subject to tearing (substantially non-tearable when used to cover portions of an object) as might be paper or foil.

A decorative background pattern such as a solid color, a printed pattern, and/or an embossed pattern can be applied to the sheet of material 10, or the sheet of material 10 can be provided with a matte or textured finish simulating the appearance of cloth or paper. Additionally, a graphic image 24 is provided on at least a selected portion of one of the upper and lower surfaces 12 and 14 of the sheet of material 10 so as to be conspicuously and prominently displayed when the sheet of material 10 is put to its intended use, as is discussed herein below. The graphic image 24 can be printed directly on the lower surface 14 of the sheet of material 10, or alternatively printed as a reversed image on the upper surface 12 of the sheet of material 10 if the sheet of material 10 is substantially transparent, or printed as a combination on both the upper and lower surfaces 12 and 14 of the sheet of material 10, thereby providing a three-dimensional effect.

The graphic image 24 can be a rendering of at least a portion of a masterpiece work of art. A “masterpiece work of art” is defined herein as any product of one of the fine arts, such as a painting or a photograph that is widely recognizable by the public and can generally be said to provide aesthetic satisfaction to the viewer. The term “masterpiece work of art” as used herein includes works by deceased artists, such as Leonardo da Vinci, Claude Monet or Norman Rockwell, as well as works by living artists that are currently recognizable, such as Thomas Kincade, Glynda Turley, Marilyn Hageman, Ansel Adams, Anne Geddes and Kim Anderson. The term “rendering of at least a portion of a masterpiece work of art” not only includes exact reproductions of an original work but will also include reproductions and partial reproductions that resemble an original masterpiece work of art, such as a forgery or an imitation, works that contain an adoption of a general style of artistic expression that is recognizable, such as the Impressionist style of painting, and works that include alterations to a famous work, such as a negative image of a work, a change in coloration of a work, or the addition of a person, object or logo to a work.

In addition, the graphic image 24 can be selected from any of a number of works of art commonly associated with the work of the Great Masters. The term “works of the Great Masters” is to be understood to mean a work of art produced by an artist generally associated with at least one of the historical periods or movements, such as but not limited to, the Renaissance period, the Baroque period, the Rococo period, the Abstract period, the Victorian period, and movements such as Impressionism, Classicism, Neoclassicism, Romanticism, Symbolism, Realism, Expressionism, Gothicism, Minimalism, Modernism, Fauvism, Cubism, Surrealism, Precisionism, Art Deco, Art Nouveau, Arts and Crafts and the like. Examples of such artists includes but are not limited to Fra Angelico, Botticelli, Donatello, Ghiberti, Ghirlandaio, Giotto, Filippino, Lippi, Mantegna, Masaccio, Perugino, Piero della Francesca, Pollaiuolo, Signorelli, Verrocchio, Andrea del Sarto, Fra Bartolommeo, Leonardo, Michelangelo, Raphael, Titian, Altdorfer, Durer, Elsheimer, Grunewald, Mabuse, Massys, Van der Weyden, Rembrandt, Henri, Delacroix, Gauguin, Chagall, Rubens, Goya, Van Gogh, Velasquez, Carracci, Carravaggio, Ribalta, Ribera, Vermeer, Cassatt, Cezanne, Degas, Monet, Manet, Renoir, Pissarro, Sisley, Toulouse-Lautrec, Rousseau, Watteau, Boucher, Tiepolo, Chardin, David, Pannini, Ingres, Mengs, Corot, Millet, Thomas Eakins, Henry Tanner, Turner, Friedrich, Constable, Blake, Alma-Tadema, Godward, Leighton, Rossetti, Millias, Hunt, Gericault, Moreau, Redon, de Chavannes, Beardsley, Tiffany, William Morris, Edvard Munch, Franz von Stuck, Kandinsky, Macke, Matisse, Picasso, Klee, Grosz, Francis Bacon, Norman Rockwell, Jackson Pollack, Salvador Dali, Georgia O'Keefe, Andy Warhol and the like.

It will be understood that the graphic image 24 may be a depiction of at least a portion of a musical score, as described in more detail hereinbelow, or the graphic image 24 may be a combination of at least a portion of a masterpiece work of art and at least a portion of a musical score.

The decorative coverings of the present invention supplement the transcendent value of a potted plant or floral grouping disposed therein, and it is this synergistic combination of art and floral grouping to which the present invention is aimed. By providing the sheet of material 10 and selectively applying the graphic image 24 to the sheet of material 10, the sheet of material 10 can be used in any of a number of ways to decoratively wrap a floral grouping or provide a decorative covering for a flower pot in accordance with the present invention.

A bonding material 26 is disposed on at least a portion of the upper surface 12 of the sheet of material 10. However, it will be understood that the bonding material 26 may alternatively be disposed on at least a portion of the lower surface 14 of the sheet of material 10 or on at least a portion of both the upper and lower surfaces 12 and 14 of the sheet of material 10. “Bonding material” as used herein refers to any type of material or thing which can be used to affect the bonding or connecting of two adjacent portions of material or sheets of material to effect the connection or bonding described herein. The term “bonding material” as used herein includes but is not limited to adhesives, such as pressure sensitive adhesives, and cohesives. Where the bonding material 26 is a cohesive, a cohesive material is placed on portions of the sheet of material 10 which will bondingly contact and bondingly engage the cohesive bonding material 26. For example, the sheet of material 10 may be provided with a cohesive binding material 26 on at least a portion of both the upper and lower surfaces 12 and 14 thereof, and the sheet of material 10 may be secured about a floral grouping or a potted plant by bondingly connecting the bonding material 26 disposed on the upper surface 12 of the sheet of material 10 to the bonding material 26 disposed on the lower surface 14 of the sheet of material 10.

The term “bonding material” also includes materials which are heat sealable, sonic sealable or vibratory sealable. The term “bonding material” as used herein also means a lacquer, which may be applied to the sheet of material 10 and, in this instance, heat, sound waves, or vibrations also must be applied to affect the sealing of the lacquer. The bonding material 26 may also be tinted or colored by using a dye, pigment or ink. U.S. Pat. No. 5,147,706 entitled “Water Based Ink On Foil And/Or Synthetic Organic Polymer” issued to Kingman on Sep. 15, 1992 and hereby expressly incorporated herein by reference, provides one water based ink which may be used to tint the bonding material 26.

Furthermore, the term “bonding material” may also refer to any heat or chemically shrinkable material, any electrical means, magnetic means, mechanical or barb-type fastening means or clamps, curl-type characteristics of the film or materials incorporated in the sheet of material which can cause the material to take on certain shapes, and any type of welding method which may weld portions of the sheet of material to itself or to the flower pot, or to both the sheet itself and the flower pot. “Bonding material” may also refer to ties, labels, bands, ribbons, strings, tapes, staples, heat sealants or combinations thereof.

“Band” when used herein refers to any material which may be secured about an object such as a flower pot, such bands commonly being referred to as elastic bands, rubber bands or non-elastic bands and may also refer to any other type of material such as an elastic or non-elastic string or elastic piece of material, non-elastic piece of material, a round piece of material, a flat piece of material, a ribbon, a piece of paper strip, a piece of plastic strip, a piece of wire, a tie wrap or a twist tie or combinations thereof or any other device capable of gathering the sheet of material to removably or substantially permanently form a crimped portion and secure the crimped portion formed in the sheet of material which may be secured about an object such as the flower pot. “Band” may also refer to a bow if desired in a particular application.

The tack level of the bonding material 26 should be controlled in most applications so that the sheet of material 10 does not destroy or substantially damage the object bonded thereto when removed from the object, or does not destroy any decorative pattern or the graphic image 24 which is applied to the upper surface 12 or lower surface 14 of the sheet of material 10.

The sheet of material 10 having the graphic image 24 thereon (as well as any other sheet of material described herein) is produced or otherwise obtained by a supplier of materials and may be sold and delivered, either directly or indirectly, to a customer (such as, but not limited to, a grower, a wholesale distributor or a retail distributor). The customer utilizes the sheet of material 10 to provide any of the embodiments of decorative covers, flower pots, ribbon material, or the like described herein, as described in more complete detail herein.

As stated above, in addition to the works of the Great Masters, other graphic images are likewise capable of enhancing the transcendent value of a floral grouping and are likewise contemplated as being within the scope of the present invention.

Shown in FIG. 3 is another version of a sheet of material designated by the reference numeral 10a which is similar to the sheet of material 10 described herein before with reference to FIG. 1, except as described herein below. The sheet of material 10a is provided with an upper surface 12a, a lower surface 14a, a first side 16a, a second side 18a, a first end 20a and a second end 22a. The sheet of material 10a is provided with graphic image 24a which is a depiction of a particular musical score on at least a portion of one of the upper and lower surfaces 12a and 14a thereof. The term “musical score” is understood to refer to the diagrammatic rendering of a well known musical composition, set forth as notes placed upon the bass and/or treble clefts and so arranged to define the order, combination, and duration with which individual notes are to be played in order to provide the associated musical composition. The sheet of material 10a bearing the graphic image 24a as illustrated in FIG. 3 falls within the scope of the present invention wherein the synergistic effect of the musical score of the graphic image 24a in combination with a floral grouping or a potted plant provides a transcendent value exceeding the sum of the graphic image 24a and the floral grouping or potted plant separately.

While the graphic image 24a is depicted as a musical score in FIG. 3, it will be understood that the graphic image 24a may be a combination of at least a portion of a masterpiece work of art and at least a portion of a musical score.

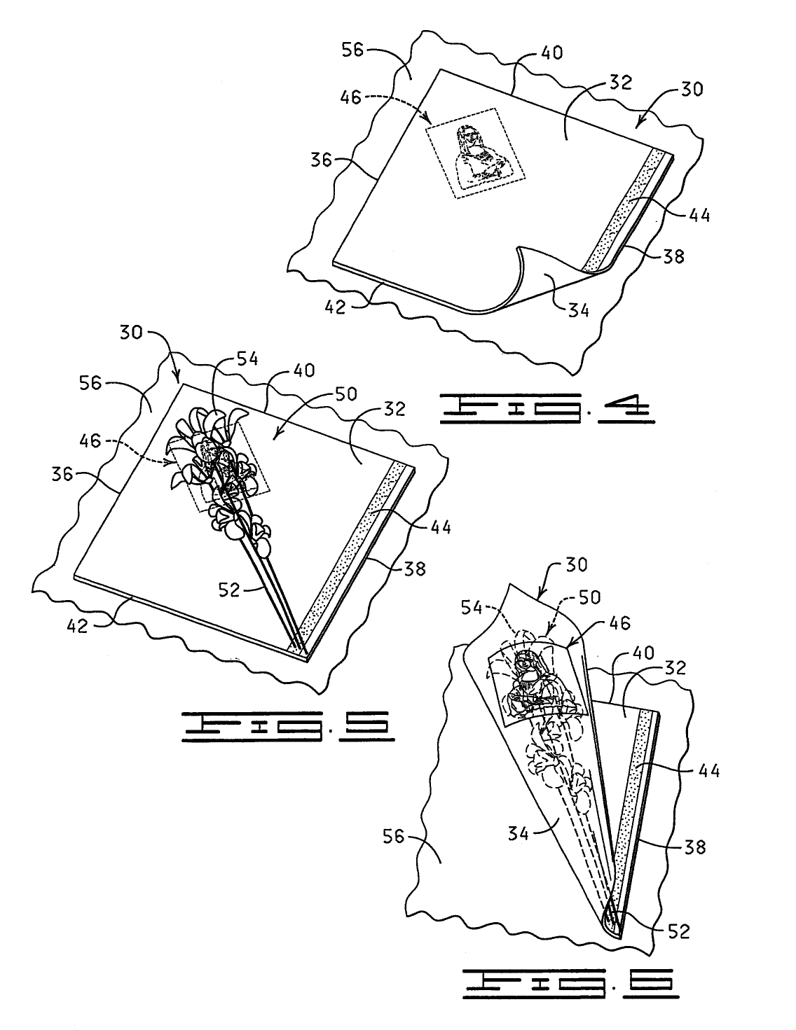

### Description of FIGS. 4-8

Turning now to FIG. 4, a sheet of material 30 constructed in accordance with the present invention is illustrated. The sheet of material 30 is similar to the sheets of material 10 and 10a described herein above with reference to FIGS. 1 and 3, except as described below. The sheet of material 30 has an upper surface 32, a lower surface 34, a first side 36, a second side 38, a first end 40, a second end 42 and a bonding material 44 provided over only a portion of the upper surface 32 of the sheet of material 30, such as a strip of bonding material 44 disposed substantially adjacent the second side 38 of the sheet of material 30. As previously described for the sheet of material 10, the sheet of material 30 can have a background color or pattern (not shown), which can be printed on the sheet of material 30 randomly. The sheet of material 30 is also provided with a graphic image 46 printed at a particular location and at a particular orientation on at least a portion of the sheet of material 30 so that the graphic image 46 is prominently displayed so as to enhance the decor of a floral grouping when the sheet of material 30 is disposed about a floral grouping. The graphic image 46 is similar to the graphic images 24 and 24a of the sheets of material 10 and 10a of FIGS. 1 and 3, respectively. In FIG. 4, the graphic image 46 is depicted as being a masterpiece work of art. However, it will be understood that the graphic image 46 may be at least a portion of a masterpiece work of art, at least a portion of a musical score, or a combination thereof.

A floral grouping 50 is diagrammatically shown in FIG. 5, the floral grouping 50 generally having a stem portion 52 and a bloom portion 54. The term “floral grouping” as used herein refers to arrangements of cut, fresh flowers, artificial flowers, a single flower, and other fresh and/or artificial flowers, and fresh and/or artificial plants or other floral materials, and such arrangements may include other secondary plants and/or ornamentation of artificial or natural materials which add to the aesthetics of the overall floral grouping 50.

FIGS. 5-7 illustrate the sheet of material 30 being wrapped about the floral grouping 50. It will be understood that the sheets of material 10 or 10a shown in FIGS. 1 and 3, respectively, may be utilized in a similar manner. However, for the sake of brevity, only the use of the sheet of material 30 to wrap the floral grouping 50 will be described in detail herein after. The sheet of material 30 is disposed upon a support surface 56, and the floral grouping 50 is disposed on the upper surface 32 of the sheet of material 30 as shown in FIG. 5 such that the floral grouping 50 is disposed in a diagonal orientation on the sheet of material 30.

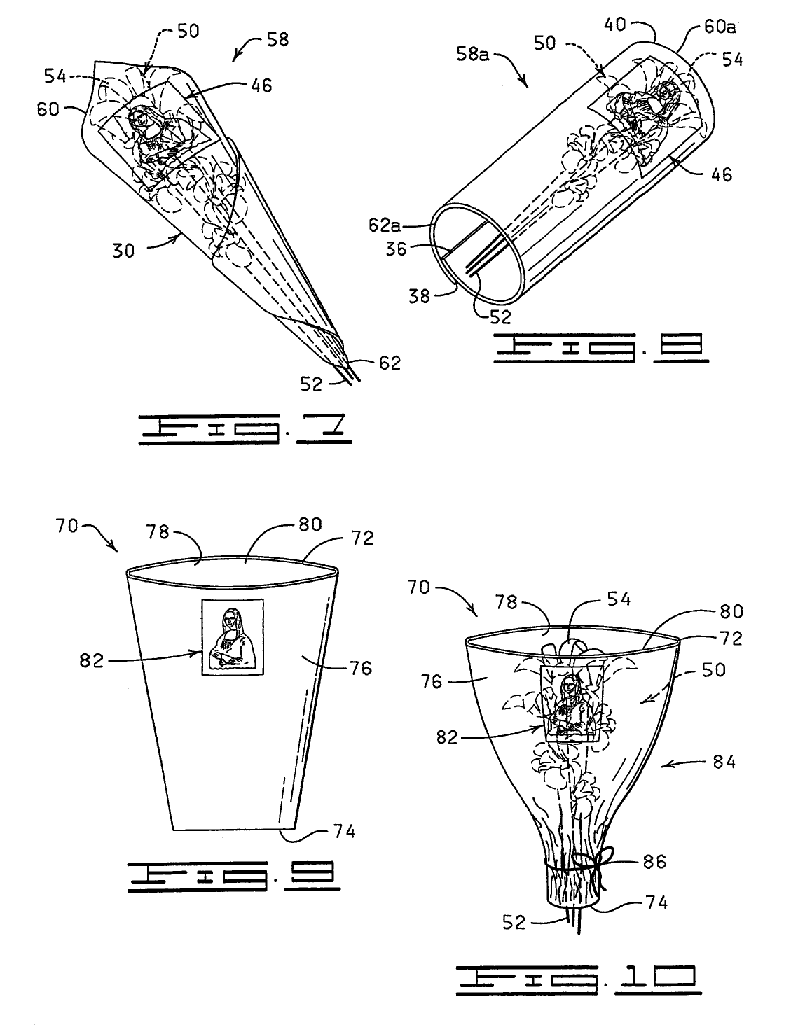

The sheet of material 30 is wrapped about the floral grouping 50 by overlapping a portion of the sheet of material 30 over another portion of the sheet of material 30. That is, for example, the second end 42 of the sheet of material 30 is placed over the floral grouping 50, as shown in FIG. 6. The floral grouping 50 is rolled in the direction toward the second side 38 until the upper surface 32 of the sheet of material 30 near the second side 38 thereof engages the lower surface 34 of the sheet of material 30, wherein the floral grouping 50 is substantially encompassed by the sheet of material 30, and the bonding material 44 disposed on the upper surface 32 of the sheet of material 30 comes into contact with the lower surface 34 of the sheet of material 30, thereby forming a decorative covering 58 which is conically-shaped, as illustrated in FIG. 7. Thus, the bloom portion 54 of the floral grouping 50 is disposed adjacent an open upper end 60 of the decorative covering 58, while the stem portion 52 of the floral grouping 50 is disposed adjacent a lower end 62 of the decorative covering 58. The graphic image 46 is prominently displayed on a selected portion of the decorative cover 54.

FIG. 8 illustrates an alternative method of wrapping the floral grouping 50 in the sheet of material 30 to provide a decorative covering 58a which is cylindrically-shaped. The floral grouping 50 is disposed upon the sheet of material 30 substantially parallel to the first side 36 of the sheet of material 30. The sheet of material 30 is wrapped generally about the stem portion 52 and the bloom portion 54 of the floral grouping 50 in a manner so as to keep first side 36 of the sheet of material 30 substantially parallel to the second side 38 of the sheet of material 30. As the floral grouping 50 is continued rolled, the first side 36 of the sheet of material 30 overlaps the opposing second side 38 thereof in a cylindrical fashion to provide the cylindrically shaped decorative wrapper 58a having an open upper end 60a and a lower end 62a. The graphic image 46 is prominently displayed on a selected portion of the decorative covering 58a.

The decorative coverings 58 and 58a formed from the sheet of material 30 in the manner described above function under ordinary handling conditions to substantially prevent damage to the floral grouping 50 disposed therein. Such damage can be, for example, crushing, breaking, bending, or bruising of the petals of the flowers of the bloom portion 54 of the floral grouping 50. By ordinary handling conditions it is meant the manner typically employed in the floral industry to wrap floral groupings for storage, shipping or sale.

### Description of FIGS. 9-12

Shown in FIG. 9 is a sleeve 70 having an open upper end 72, an open lower end 74, an outer peripheral surface 76 and an inner peripheral surface 78 which defines a retaining space 80. A graphic image 82 is provided on at least a portion of the outer peripheral surface 76 of the sleeve 70. In FIG. 9, the graphic image 82 is depicted as being a masterpiece work of art. However, it will be understood that the graphic image 82 may be at least a portion of a musical score alone or in combination with at least a portion of a masterpiece work of art.

The sleeve 70 may be formed of any of the flexible materials disclosed herein, such as but not limited to, paper, foil, polymeric film, metallized film, cloth, laminates thereof and combinations thereof. In the alternative, the sleeve 70 may be formed of a rigid or semi-rigid material, such as but not limited to, cardboard or rigid plastic, or a laminate or combination of cardboard or rigid plastic with at least one of paper, foil, polymeric film, metallized film, cloth and combinations thereof.

The sleeve 70 is generally conically shaped and tapered outwardly from the lower end 74 toward a larger diameter at the open upper end 72 thereof. However, it is to be understood that the sleeve 70 can be, for example, cylindrical, frusto-conical, a combination of both frusto-conical and cylindrical, or any other shape, whether geometric, non-geometric, asymmetrical and/or fanciful, as long as it functions in accordance with the present invention.

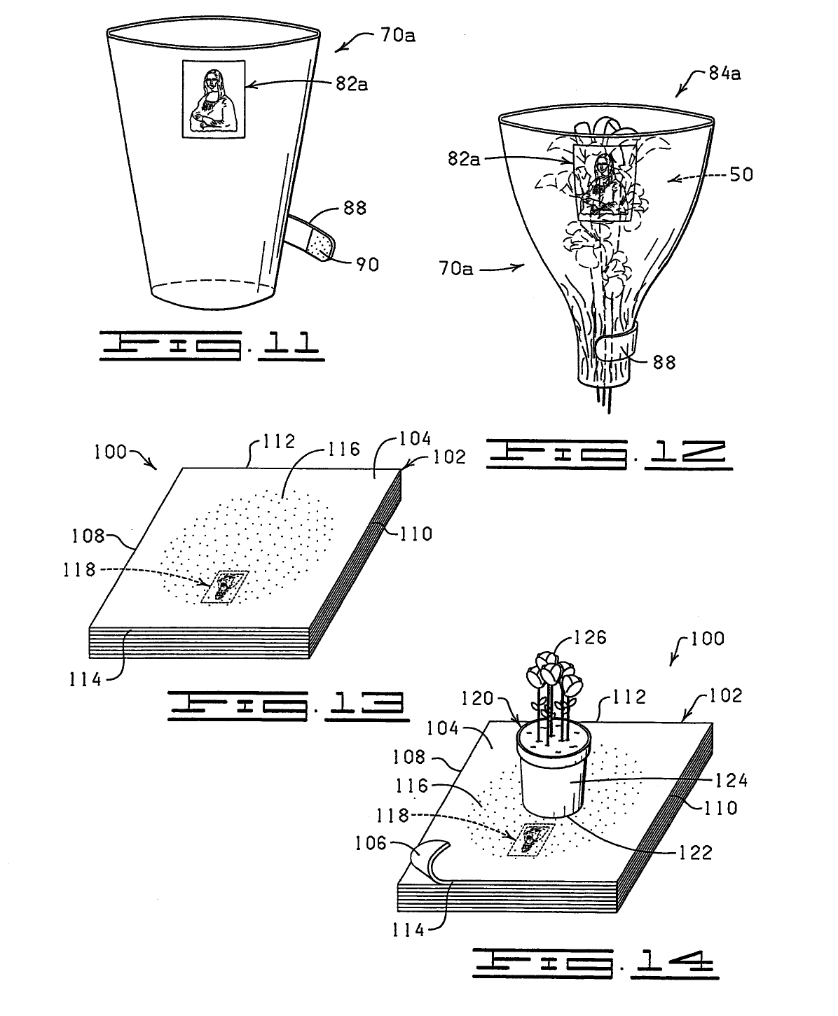

FIG. 10 illustrates the floral grouping 50 disposed within the retaining space 80 of the sleeve 70, thereby forming a decorative covering 84 for the floral grouping 50. The graphic image 82 is prominently displayed on a selected portion of the decorative covering 84. Generally, the bloom portion 54 of the floral grouping 50 is disposed substantially adjacent the open upper end 72 of the sleeve 70 and a portion of the stem portion 52 of the floral grouping 50 extends through the open lower end 74 of the sleeve 70. While the sleeve 70 has been shown herein as having the open lower end 74, it should be understood that the lower end of the sleeve 70 could be closed. In such instance, the stem portion 52 of the floral grouping 50 would be confined in the retaining space 80 of the sleeve 70. A portion of the sleeve 70 may be crimped about the stem portion 52 of the floral grouping 50 for holding the sleeve 70 about the floral grouping 50, or the sleeve 70 can be crimped and held about the floral grouping 50 by a banding element 86 tied around the sleeve 70, such as is shown in FIG. 10. The step of tying the banding element 86 about a portion of the sleeve 70 results in crimping a portion of the sleeve 70 about the stem portion 52 of the floral grouping 50. While the banding element 86 has been illustrated herein as a string or ribbon, it is to be understood that the banding element 86 can be elastic or non-elastic bands, elastic or non-elastic string, an elastic or non-elastic piece of material, a round piece of material, a flat piece of material, a ribbon, a piece of paper strip, a piece of plastic strip, a piece of wire, a tie wrap, a twist tie or combinations thereof.

However, it will be understood that other methods and elements for crimping the sleeve 70 about the floral grouping 50 can be employed. For example, a sleeve 70a is shown in FIGS. 11 and 12 and is substantially similar to the sleeve 70 described herein before with reference to FIGS. 9 and 10, except that the sleeve 70a is provided with a cinching tab 88 having a bonding material 90 applied to a portion thereof. In a method of use of the sleeve 70a shown in FIGS. 11 and 12, a floral grouping 50 is disposed in the sleeve 70a as described above for disposing the floral grouping 50 in the sleeve 70, and the sleeve 70a is secured thereabout via the cinching tab 88 to form a decorative covering 84a, as shown in FIG. 12. That is, a portion of the sleeve 70a adjacent the cinching tab 88 is crimped about at least a portion of the stem portion 52 of the floral grouping 50 disposed therein, and the cinching tab 88 holds the sleeve 70a in such a position so that the floral grouping 50 is secured therein.

When the sleeve 70 is formed of a rigid or semi-rigid material, the sleeve 70 may be provided with a configuration similar to that of FIG. 10, wherein the configuration of the sleeve 70 secures and holds the sleeve 70 in a position about the floral grouping 50. A rigid or semi-rigid sleeve 70 may also be utilized with any of the securing elements described herein, either to further secure the sleeve 70 in a position about the floral grouping 50 or simply to provide a decorative effect to the decorative covering 84 formed therefrom.

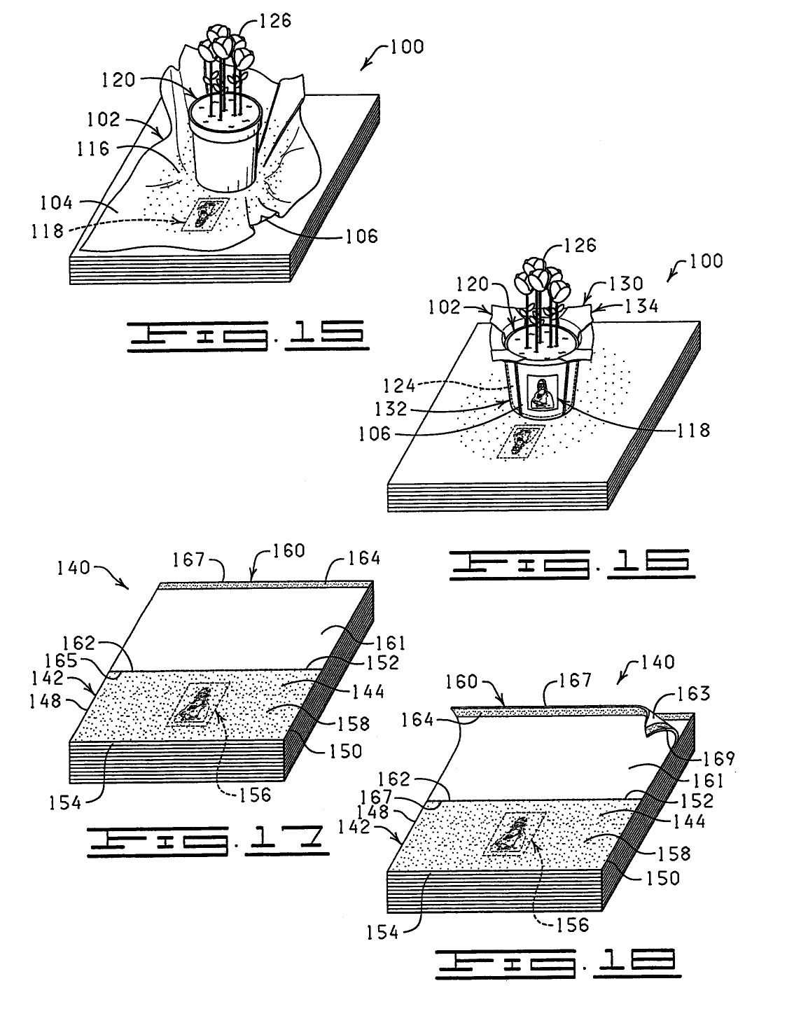

### Description of FIGS. 13-16

The material supplier supplies at least one sheet of material having a graphic image thereon as described herein to a customer, and desirably, the material supplier supplies a plurality of sheets of material having a graphic image thereon to a customer, wherein the plurality of sheets of material may be provided as separate, individual sheets or in the form of a roll or pad. Referring to FIGS. 13 through 16, illustrated therein is a pad 100 formed from a plurality of sheets of material 102, wherein each of the sheets of material 102 is similar to the sheets of material 10 and 10a described herein previously with respect to FIGS. 1 and 3, except as described hereinbelow. As shown in FIG. 13, each sheet of material 102 has an upper surface 104, a lower surface 106 (FIG. 14), a first side 108, a second side 110, a first end 112 and a second end 114. The upper surface 104 of each sheet of material 102 has a bonding material 116 disposed on at least a portion thereof, wherein the bonding material 116 is substantially similar to the bonding material 26 disposed on the sheet of material 10 as described herein before with reference to FIG. 1. Each of the sheets of material 102 is provided with a graphic image 118. While the graphic image 118 has been illustrated herein as being a masterpiece work of art, it should be understood that the graphic image 118 may be at least a portion of a musical score, alone or in combination with at least a portion of a masterpiece work of art.

As shown in FIG. 14, a flower pot 120 having a lower end 122 and an outer peripheral surface 124 and a floral grouping or plant 126 disposed therein is disposed on the top sheet of material 102 of the pad 100. “Flower pot” or “pot”, as used herein, refers to containers used for holding floral groupings or potted plants. Examples of such flower pots are clay pots, plastic pots and the like. The flower pot defines a receiving space adapted to receive floral groupings. The floral grouping may be disposed within the receiving space of the flower pot along with a suitable growing medium, a floral foam or combinations thereof. It will also be understood that in some cases the floral grouping, and any appropriate growing medium or other retaining medium, may be disposed in a flower pot cover without the flower pot if the flower pot cover is adapted to contain the growing medium.

A portion of the top sheet of material 102 of the pad 100 is separated from the next underlying sheet of material 102 of the pad 100 and wrapped about the flower pot 120. It should be appreciated that the lower surface 106 of the top sheet of material 102 should be substantially non-sticking, or at least releasably sticking, to the bonding material 116 disposed on the upper surface 104 of the adjacently disposed sheet of material 102 in the pad 100. The bonding material 116 may be a cohesive, and will therefore only bond to itself or to another cohesive material. Alternatively, the lower surface 106 of the sheet of material 102 may be rendered non-sticking or releasably sticking by selecting an appropriate foil or polymer film for the lower surface 106 of the sheets of material 102 or coating the lower surface 106 of the sheets of material 102 with wax, or any conventional wax-like substance.

The top sheet of material 102 is wrapped around the outer peripheral surface 124 of the flower pot 120, substantially as shown in FIG. 15. If the bonding material 116 is an adhesive, at least a portion of the bonding material 116 of the sheet of material 102 is placed into adhering contact with at least a portion of the outer peripheral surface 124 of the flower pot 120.

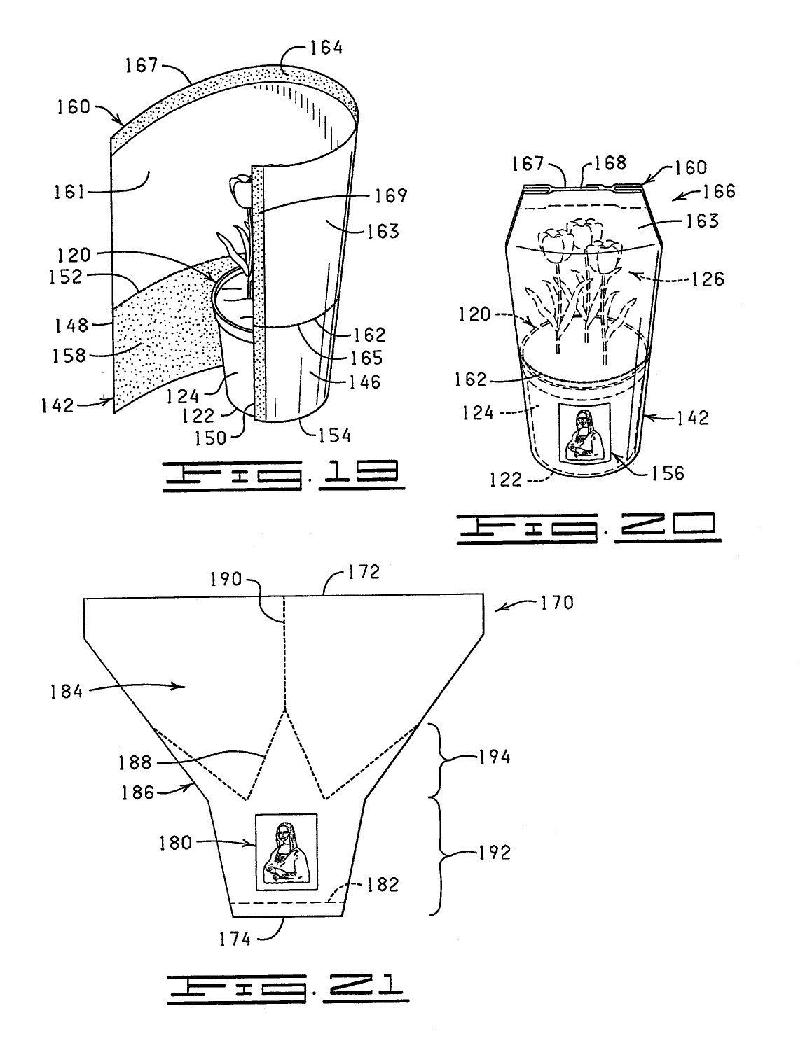

While the sheet of material 102 is being wrapped around and adhesively secured to the flower pot 120, the sheet of material 102 is shaped into a decorative covering 130, substantially as shown in FIG. 16, such that the graphic image 118 is prominently displayed on a selected portion of the decorative covering 130.

The sheet of material 102 is shaped into the decorative covering 130 in such a manner that the portion of the sheet of material 102 containing the graphic image 118 remains substantially undistorted due to the presence of the overlapping folds formed in the decorative covering 130.

The decorative covering 130 is provided with a base portion 132 and a skirt portion 134, wherein the base portion 132 of the decorative covering 130 surrounds and encompasses the outer peripheral surface 124 of the flower pot 120 while the skirt portion 134 extends outwardly and downwardly therefrom. However, it should be understood that the skirt portion 134 of the decorative covering 130 could be formed in such a manner that the skirt portion 134 extends outwardly from the base 132 of the decorative covering 130 and surrounds a portion of the floral grouping or plant 126 disposed in the flower pot 120. It should be noted that the bonding material 116 can be disposed on only the portion of the sheet of material 102 which is formed into the base portion 132 of the decorative covering 130 such that the skirt portion 134 of the decorative covering 130 is substantially free of bonding material 116.

Finally, the flower pot 120 and the sheet of material 102, now adhesively secured to the flower pot 120 in the shape of the decorative covering 130, are removed from the pad 100. The pad 100 is then ready for wrapping the new top sheet of material 102 about another flower pot 120.

It should be appreciated that separating the top sheet of material 102 from the pad 100 and wrapping the top sheet of material 102 about the flower pot 120 to form the decorative covering 130 can be performed manually or in an automated fashion. It should also be appreciated that single, separate sheets of material (such as a sheet of material 10 or 10a as shown in FIGS. 1 and 3) or sheets of material dispensed from a continuous roll (not shown) may be used rather than a pad 100 of sheets of material 102.

The steps of the method just described may be varied in a number of ways. For example, the top sheet of material 102 may be completely separated from the pad 100 before the flower pot 120 is disposed upon the sheet of material 102, anytime during the wrapping of the sheet of material 102 about the flower pot 120, or after the formation of the sheet of material 102 into the decorative covering 130 adhesively secured to the flower pot 120.

### Description of FIGS. 17-20

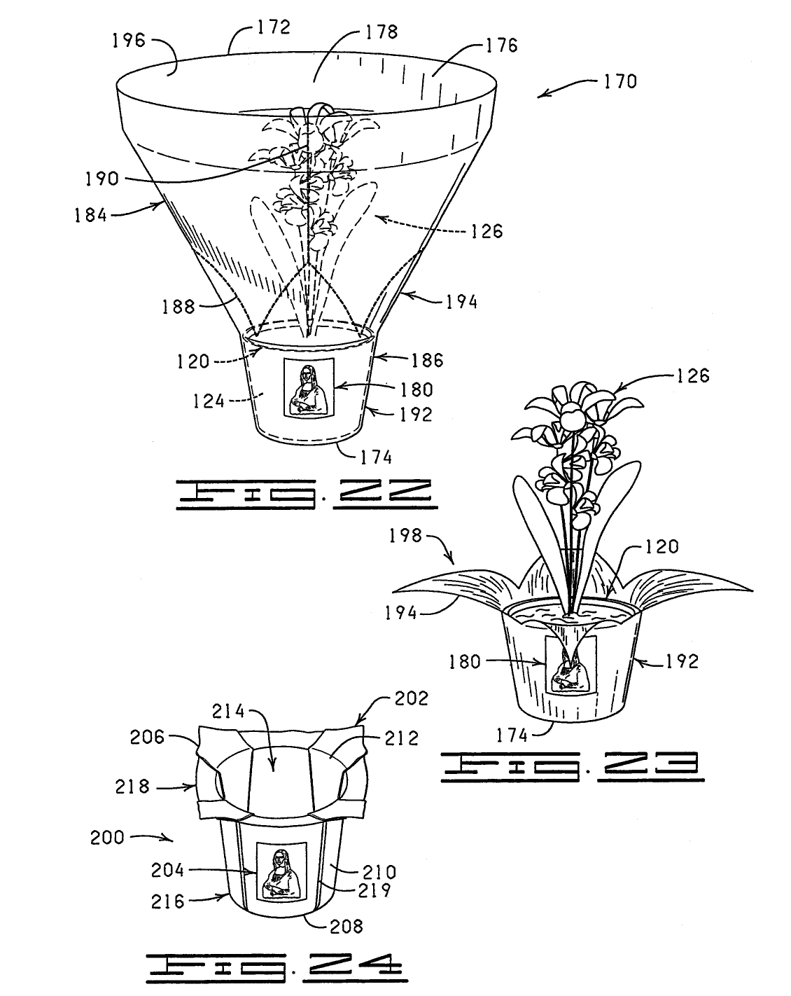

With reference to FIGS. 17-20, illustrated therein is a pad 140 containing a plurality of sheets of material 142. As shown in FIG. 17, each sheet of material 142 has an upper surface 144, lower surface 146 (FIG. 19), a first side 148, a second side 150, a first end 152, a second end 154, a graphic image 156 disposed thereon, and a bonding material 158 disposed on at least a portion of the upper surface 144 thereof. The sheets of material 142 may be constructed of any of the flexible materials disclosed herein, such as but not limited to, paper, foil, polymeric film, metallized film, cloth, laminates thereof and combinations thereof. In the alternative, the sheets of material 142 may be formed of a rigid or semi-rigid material, or a laminate or combination of a rigid or semi-rigid material with at least one of paper, foil, polymeric film, metallized film, cloth and combinations thereof.

Each of the sheets of material 142 is also provided with a sheet extension 160 which extends from the first end 152 of the sheet of material 142 and extends between the first and second sides 148 and 150 of the sheet of material 142 and is detachable therefrom via a detaching element 162, such as a line of perforations, as shown in FIGS. 17-20. The sheet extension 160 is provided with an upper surface 161, a lower surface 163, a lower end 165 congruent with the detaching element 162, and an upper end 167. Further, a strip of bonding material 169 is disposed on the lower surfaces 146 and 163, respectively, of each of the sheets of material 142 and the sheet extension 160 connected thereto. The strip of bonding material 169 is disposed adjacent the second side 150 of the sheet of material 142 and extends between the first and second ends 152 and 154 of the sheet of material 142 and between the upper and lower ends 167 and 165 of the sheet extension 160, substantially as shown in FIG. 19.

The graphic image 156 is printed on at least a portion of at least one of the upper and lower surfaces 144 and 146, respectively, of the sheet of material 142. In FIGS. 17-20, the graphic image 156 is depicted as being a masterpiece work of art. However, it will be understood that the graphic image 156 may be at least a portion of a musical score, alone or in combination with at least a portion of a masterpiece work of art.

The lower surface 146 of each sheet of material 142 can be substantially non-sticking or releasably-sticking with respect to the bonding materials 158 and 169, as described above for the pad 100 containing the plurality of sheets of material 102 shown in FIGS. 13-16. The bonding material 158 is provided on at least a portion of the upper surface 144 of the sheet of material 142 for bondingly connecting the sheet of material 142 to the flower pot 120. The bonding material 169 is provided on the lower surface 146 of the sheet of material 142 and on the lower surface 163 of the sheet extension 160 to join the first and second sides 148 and 150 of the sheet of material 142 in the attachment of the sheet of material 142 about the flower pot 120 and to seal the sheet extension 160 about the floral grouping or plant 126 disposed in the flower pot 120. The sheet extension 160 is also provided with a bonding material 164 disposed on a portion of the upper surface 161 and adjacent the upper end 167 thereof, wherein the bonding material 164 may be an adhesive or cohesive material.

As best illustrated by FIGS. 18 and 19, the top sheet of material 142 of the pad 140 is separated from the pad 140. The separated sheet of material 142 having the sheet extension 160 attached thereto is wrapped about the flower pot 120 with the bonding material 158 adjacent to the outer peripheral surface 124 of the flower pot 120, as shown in FIG. 19. As the sheet of material 142 is disposed around the flower pot 120, at least a portion of the bonding material 158 disposed on the upper surface 144 of the sheet of material 142 is placed in contact with the outer peripheral surface 124 of the flower pot 120 to secure the sheet of material 142 to the flower pot 120.

After the sheet of material 142 is wrapped completely about the flower pot 120, portions of the sheet of material 142 overlap. The bonding material 169 disposed on the lower surface 146 of the overlapping portion of the sheet of material 142 is placed into securing contact with the upper surface 144 of the overlapping portion of the sheet of material 142 to further hold the sheet of material 142 about the flower pot 120 such that the graphic image 156 is prominently displayed. Likewise, the bonding material 169 disposed on the lower surface 163 of an overlapping portion of the sheet extension 160 is placed into securing contact with the upper surface 161 of an overlapping portion of the sheet extension 160 to hold the sheet extension 160 about the floral grouping or plant 126 disposed in the flower pot 120.

Finally, the bonding material 164 disposed on the upper surface 161 of the sheet extension 160 substantially adjacent the upper end 167 thereof connects to itself and, in cooperation with the sheet of material 142, forms a decorative covering 166 having a closed upper end 168 (FIG. 20). The sheet extension 160 can be removed from the decorative covering 166 by tearing along the detaching element 162. The remaining portion of the decorative covering 166 remains adhesively secured to the outer peripheral surface 124 of the flower pot 120.

It should be appreciated that the steps of removing the top sheet of material 142 from the pad 140, wrapping the separated sheet of material 142 about the flower pot 120, and forming the sheet extension 160 about the floral grouping or plant 126 disposed in the flower pot 120 can be performed manually or in an automated fashion. It should also be appreciated that the sheet extension 160 may be substantially transparent for displaying the floral grouping or plant 126 disposed in the flower pot 120.

It will be appreciated that the sheets of material 142 can be provided as single, separate sheets of material (such as the sheets of material 10 or 10a described herein before with reference to FIGS. 1 and 3) or can be dispensed from a continuous roll of sheets of material (not shown) instead of in the pad 140.

### Description of FIGS. 21-23

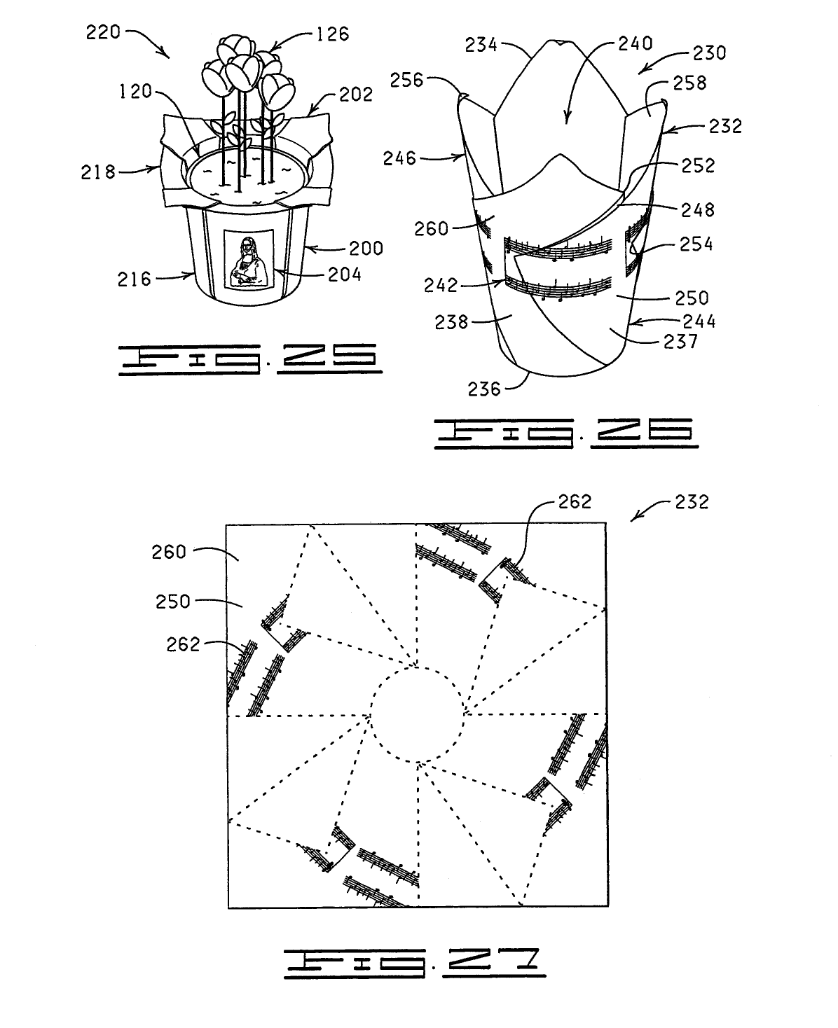

Shown in FIG. 21 is a sleeve 170 fashioned to be disposed about the flower pot 120, the flower pot 120 having been described in detail hereinbefore with reference to FIG. 20. The sleeve 170 has an upper end 172, a closed lower end 174 and an opening 176 (FIG. 22) at the upper end 172 thereof. While the lower end 174 of the sleeve 170 is shown as being closed, it will be understood that the lower end 174 of the sleeve 170 could be open.

The sleeve 170 may be formed of any of the flexible materials disclosed herein, such as but not limited to, paper, foil, polymeric film, metallized film, cloth, laminates thereof and combinations thereof. In the alternative, the sleeve 170 may be formed of a rigid or semi-rigid material, such as but not limited to, cardboard or rigid plastic, or a laminate or combination of cardboard or rigid plastic with at least one of paper, foil, polymeric film, metallized film, cloth and combinations thereof.

Opening the sleeve 170 as shown in FIG. 22 creates an inner retaining space 178 for receiving disposition of the flower pot 120 containing the floral grouping or plant 126. A graphic image 180 is printed on the sleeve 170, and the graphic image 180 is depicted as being at least a portion of a masterpiece work of art. However, it will be understood that the graphic image 180 may be at least a portion of a musical score, alone or in combination with at least a portion of a masterpiece work of art.

A portion of the lower end 174 of the sleeve 170 can be inwardly folded to form one or more gussets 182 (FIG. 21) for permitting the lower end 174 of the sleeve 170 to conform to a circular bottom of the flower pot 120 disposed in the inner retaining space 178 of the sleeve 170. While the sleeve 170 is illustrated with a gusset 182 in the lower end 174 thereof, it is to be understood that the gusset 182 could also be formed in a side portion of the sleeve near the lower end 174 of the sleeve.

As shown in FIG. 21, the sleeve 170 generally has an upper portion 184 and a lower portion 186. The lower portion 186 of the sleeve 170 is generally sized to contain the flower pot 120. The upper portion 184 of the sleeve 170 is sized to substantially surround and encompass the floral grouping or plant 126 that is disposed in the flower pot 120. A detaching element 188, such as a line of perforations, separates the upper and lower portions 184 and 186 of the sleeve 170 to enable a detachment of the upper portion 184 of the sleeve 170 from the lower portion 186 of the sleeve 170. An additional detaching element 190, such as a line of substantially vertically disposed perforations, may also be provided to assist in removal of the upper portion 184 from the lower portion 186 of the sleeve 170.

The lower portion 186 of the sleeve 170 further comprises a base portion 192 and a skirt portion 194. The base portion 192 is that part of the lower portion 186 of the sleeve 170 which, when the flower pot 120 is placed into the lower portion 186, has an inner peripheral surface 196 which is substantially adjacent to and surrounds the outer peripheral surface 124 of the flower pot 120. The skirt portion 194 of the sleeve 170 extends above the flower pot 120 and surrounds at least a portion of the floral grouping or plant 126 disposed in the flower pot 120.

As previously stated, the upper portion 184 of the sleeve 170 is separable from the lower portion 186 of the sleeve 170 by tearing the upper portion 184 away along the detaching elements 188 and 190. Upon removal of the upper portion 184 from the lower portion 186 of the sleeve 170, the base portion 192 surrounds the flower pot 120 and the skirt portion 194 extends from the base portion 192 and surrounds at least a portion of the floral grouping or plant 126, thereby forming a decorative covering 198 for the flower pot 120 having the floral grouping or plant 126 disposed therein, as shown in FIG. 23. The graphic image 180 is prominently displayed on a selected portion of the decorative covering 198.

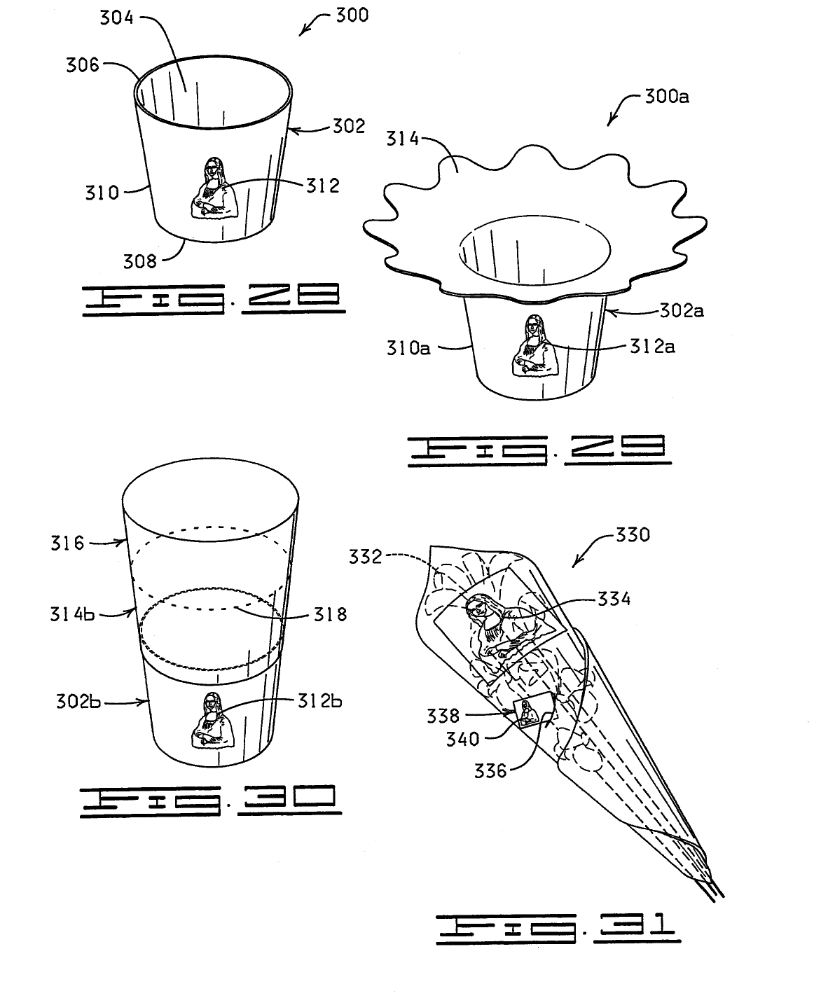

### Description of FIGS. 24-25

FIG. 24 illustrates a preformed flower pot cover 200 formed from a sheet of material 202. The sheet of material 202 is provided with a graphic image 204 disposed on at least a portion thereof, wherein the graphic image 204 is depicted as being a masterpiece work of art. However, it will be understood that the graphic image 204 may be at least a portion of a musical score, alone or in combination with at least a portion of a masterpiece work of art. The graphic image 204 is positioned on the sheet of material 202 such that when the sheet of material 202 is formed into the preformed flower pot cover 200, the graphic image 204 is not concealed and is not substantially distorted by the manner of forming the preformed flower pot cover 200.

The preformed flower pot cover 200 has an upper end 206, a lower end 208, and an outer peripheral surface 210. An opening 212 intersects the upper end 206 of the preformed flower pot cover 200, thereby forming an inner retaining space 214 into which the flower pot 120 can be disposed as shown in FIG. 25. The preformed flower pot cover 200 is provided with a base portion 216 and a skirt portion 218. The base portion 216 of the preformed flower pot cover 200 is sized to substantially surround and encompass the flower pot 120 disposed therein, while the skirt portion 218 extends outwardly and downwardly therefrom. However, it should be understood that the skirt portion 218 of the preformed flower pot cover 200 could be formed in such a manner that the skirt portion 218 extends outwardly from the base portion 216 and surrounds and encompasses at least a portion of the floral grouping or plant 126 disposed in the flower pot 120, wherein the skirt portion 218 is disposed in a position similar to that illustrated and described hereinbefore for the skirt portion 194 of the decorative covering 198 of FIG. 23.

The base portion 216 of the preformed flower pot cover 200 includes a plurality of overlapping folds 219 which are located at predetermined positions on the preformed flower pot cover 200 and incorporate predetermined portions of the sheet of material 202 from which the preformed flower pot cover 200 is formed. The overlapping folds 219 may be connected by any suitable bonding method using any suitable bonding material, such as heat sealing or with an adhesive or cohesive. The overlapping folds 219 of the base portion 216 of the preformed flower pot cover 200 provide structural integrity to the base portion 216 and cooperate to maintain the base portion 216 in the predetermined shape of the preformed flower pot cover 200.

By positioning the overlapping folds 219 at predetermined positions, the portions of the sheet of material 202 incorporated into the overlapping folds 219 can be controlled. In this manner, incorporation of a portion of the graphic image 204 in the overlapping folds 219 of the base portion 216 of the preformed flower pot cover 200 can be prevented, thus preventing or reducing distortion of the graphic image 204. That is, rather than forming overlapping folds at various and random positions on the preformed flower pot cover 200, the positioning and direction of the overlapping folds 219 are controlled to prevent incorporation of the portion of the sheet of material 202 containing the graphic image 204 therein and to prevent concealment or substantial distortion of the graphic image 204 by the overlapping folds 219.

There are various devices and associated methods for forming such a preformed decorative cover 200 as shown in FIG. 24. Such devices and associated methods are described for example in U.S. Pat. No. 5,073,161 entitled “APPARATUS OF MAKING A FLOWER POT OR FLOWER POT COVER WITH CONTROLLED PLEATS” issued to Weder et al on Dec. 17, 1991; U.S. Pat. No. 5,228,934 entitled “METHOD OF FORMING A FLOWER POT OR FLOWER POT COVER WITH CONTROLLED PLEATS” issued to Weder et al on Jul. 20, 1993; and U.S. Pat. No. 5,501,039 entitled “METHOD OF FORMING A FLOWER POT OR FLOWER POT COVER WITH CONTROLLED PLEATS” issued to Weder et al on Mar. 26, 1996, the Specifications of which are all hereby expressly incorporated by reference herein.

In a method of use shown in FIGS. 24 and 25, the flower pot 120 containing a floral grouping or plant 126 is disposed in the inner retaining space 214 of the preformed flower pot cover 200, whereby the preformed flower pot cover 200 provides a decorative covering 220 for the flower pot 120. The base portion 216 of the preformed flower pot cover 200 is substantially adjacent to and surrounds the outer peripheral surface 124 of the flower pot 120, while the skirt portion 218 of the preformed flower pot cover 200 extends from the base portion 216 of the preformed flower pot cover 200 and surrounds a portion of the floral grouping or plant 126 disposed in the flower pot 120 such that the graphic image 204 is prominently displayed on a selected portion of the decorative covering 220.

### Description of FIGS. 26 and 27

Shown in FIG. 26 and designated therein by the general reference numeral 230 is another version of a preformed flower pot cover constructed in accordance with the present invention. The preformed flower pot cover 230 is formed of a generally square-shaped, flexible sheet of material 232 shown in FIG. 27. The preformed flower pot cover 230 includes an open upper end 234, a substantially closed lower end 236, a sidewall 237 having an outer peripheral surface 238, and a retaining space 240. The preformed flower pot cover 230 is provided with a graphic image 242 disposed on at least a portion of the outer peripheral surface 238 thereof such that the graphic image 242 is prominently displayed on a selected portion of the preformed flower pot cover 230. The graphic image 242 is illustrated as at least a portion of a musical score. However, it will be understood that the graphic image 242 may be at least a portion of a masterpiece work of art, alone or in combination with at least a portion of a musical score.

The preformed flower pot cover 230 is further characterized as having a base portion 244 and a skirt portion 246. The base portion 244 of the preformed flower pot cover 230 is formed to include a preselected number of overlapping folds 248 and a corresponding number of panel sections 250 which are substantially free of folds, creases and score lines. By forming the panel sections 250 to be substantially free of folds, creases or score lines, the outer surface of each of the panel sections 250 is smooth, and thus the graphic image 242 may be selectively provided on the sheet of material 232 so as to be displayed on the panel sections 250 in such a manner that the graphic image 242 is displayed on the outer peripheral surface 238 of the preformed flower pot cover 230 without being substantially distorted or mutilated by numerous folds or creases.

More specifically, each of the overlapping folds 248 of the base portion 244 include a first fold 252 and a corresponding second fold 254, which cooperate to form a substantially Z-shaped configuration. The first fold 252 is substantially vertically oriented along the length of the sidewall 237 while the second fold 254 is angled relative to the length of the sidewall 237 at an angle ranging from about 5 degrees to about 60 degrees. The overlapping folds 248 provide mechanical strength to the base portion 244 for enabling the base portion 244 to stand upright on the substantially closed lower end 234 of the preformed flower pot cover 230. Thus, the overlapping folds 248 permit relatively thin sheets of material such as films to be utilized to form the preformed flower pot cover 230.

The skirt portion 246 of the preformed flower pot cover 230 includes four petal-like portions, only one of which is designated by the reference numeral 256. Each flared petal-like portion 256 terminates with a pointed end which is formed by one of the four corners of the square-shaped sheet of material 232. Further, each petal-like portion 256 extends a distance upwardly from the base portion 244 terminating with the pointed end of the flared petal-like portion 256.

Referring now to FIG. 27, the sheet of material 232 is characterized as having an upper surface 258 (FIG. 26) and a lower surface 260 (FIG. 27). The lower surface 260 is illustrated as being provided with the graphic image 242 selectively printed on only the portions of the sheet of material 232 which form the panel sections 250 of the preformed flower pot cover 230. In addition, the graphic image 242 is printed on the sheet of material 232 in portions 262 such that one portion 262 will register with another portion 262 upon formation of the preformed flower pot cover 230 whereby the graphic image 242 extends continuously about the outer peripheral surface 238 of the sidewall 237 of the preformed flower pot cover 230, as shown in FIG. 26.

While the graphic image 242 is illustrated as being printed on the sheet of material 232 in portions 262 in FIG. 27, it will be understood that the graphic image 242 may be printed throughout the sheet of material 232 and not only on the portions 262 of the sheet of material 232 which form the panel sections 250 of the preformed flower pot cover 230. However, when the graphic image 242 is printed throughout the sheet of material 232, it is desired that the portions of the graphic image 242 displayed on the outer peripheral surface 238 of the sidewall 237 of the preformed flower pot cover 230 be in register such that the graphic image 242 extends continuously about the outer peripheral surface 238 of the sidewall 237 of the preformed flower pot cover 230. In addition, it will further be understood that the graphic image 242 may be provided only on the portions of the sheet of material 232 which will form the panel sections 250 of the preformed flower pot cover 230 such that the alignment of the graphic image 242 in the area of the second fold 254 of the overlapping folds 248 is not required. Such sheets of material and methods for forming preformed flower pot covers therefrom are disclosed in U.S. Ser. No. 60/206,563 filed May 22, 2000, entitled “FLOWER POT COVER”, the Specification of which is hereby expressly incorporated herein by reference.

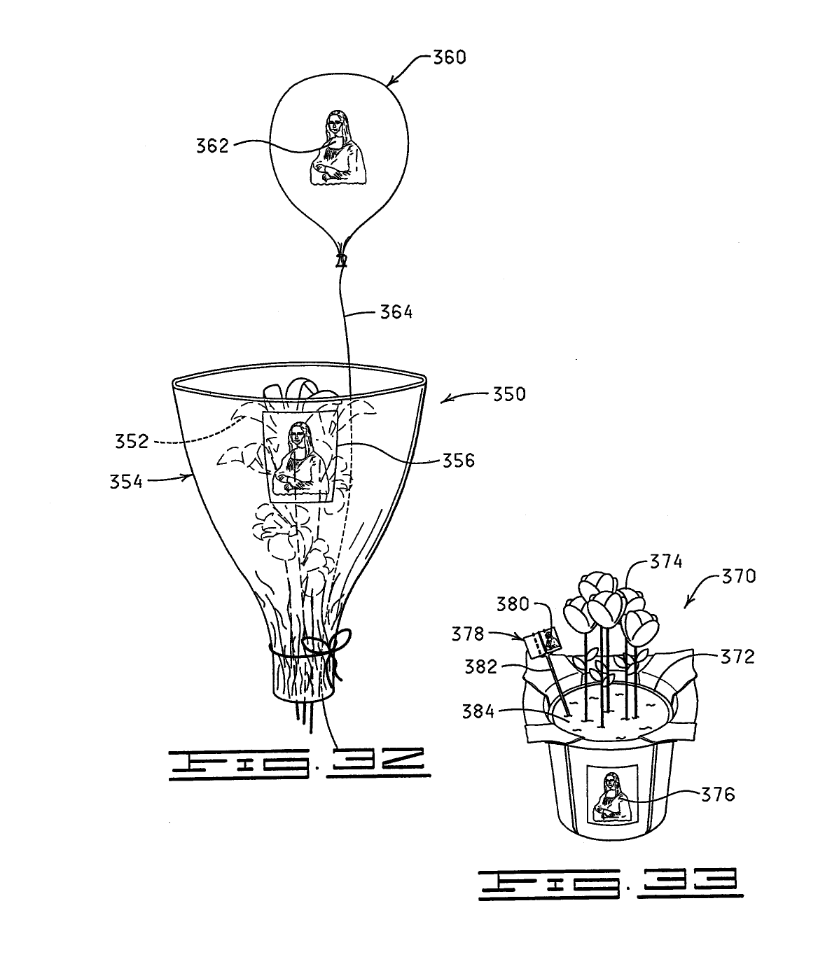

FIGS. 28, 29 and 30 illustrate flower pot covers formed of a flexible, rigid or semi-rigid shape-sustaining material and having a graphic image disposed on at least a portion thereof. In reference to FIG. 28, a flower pot cover 300 is shown therein, and the flower pot cover 300 comprises a base portion 302 constructed of a thermoplastic material or a thermoset material. The base portion 302 defines a receiving space 304 which is sized and shaped so as to substantially encompass and surround an outer surface of a flower pot. The base portion 302 has an upper end 306, a lower end 308, and a sidewall 310 extending between the upper end 306 and the lower end 308 of the base portion 302. The sidewall 310 of the base portion 302 is smooth and substantially devoid of overlapping folds. The base portion 302 of the flower pot cover 300 has a graphic image 312 disposed on at least a portion thereof wherein the graphic image 312 is visible on at least a portion of the sidewall 310 thereof. The graphic image 312 is similar to the graphic images described in detail herein, and is selected from the group consisting of a rendering of at least a portion of a masterpiece work of art, a rendering of at least a portion of a work of art of a Great Master, a rendering of at least a portion of a musical score, and combinations thereof.

The lower end 308 of the base portion 302 of the flower pot cover 300 may be provided with an open bottom or a closed bottom. Alternatively, the lower end 308 of the base portion 302 of the flower pot cover 300 may be provided with a partially closed bottom wherein at least one open area is formed in the partially closed bottom.

Shown in FIG. 29 is a flower pot cover 300a, which is similar to the flower pot cover 300 described herein above, except that the flower pot cover 300a, in addition to having a base portion 302a and a graphic image 312a disposed thereon, is further provided with a skirt 314 extending from a sidewall 310a of the base portion 302a of the flower pot cover 300a. The skirt 314 may be an extension of the base portion 302a and therefore integrally connected to the base portion 302a, or the skirt 314 may be formed separately from the base portion 302a. When the skirt 314 is formed separately from the base portion 302a, the skirt 314 may simply disposed adjacent the base portion 302a and extend from the base portion 302a, or the skirt 314 may be connected to at least a portion of the sidewall 310a of the base portion 302a.

Shown in FIG. 30 is a flower pot cover 300b that is similar to the flower pot covers 300 and 300a, except that the flower pot cover 300b, in addition to having a base portion 302b and a graphic image 312b disposed thereon, may further comprise a sleeve portion 316 that extends above at least a portion of the base portion 302b and extends about at least a portion of a floral grouping (not shown) when the floral grouping is disposed within the flower pot cover 300b.

The flower pot cover 300b is shown herein as further being provided with a skirt 314b; however, it is to be understood that the flower pot cover 300b may include the base portion 302b and the sleeve portion 316 and may not include a skirt. When the flower pot cover 300b is provided with a skirt 314b, the sleeve portion 316 may be connected to the skirt 314b of the flower pot cover 300b, or simply may be collated with the base portion 302b of the flower pot cover 300b. The sleeve portion 316 may be provided with an open upper end or a closed upper end, and the sleeve portion 316 may be detachable from the remainder of the flower pot cover 300b. When the sleeve portion 316 is attached to the skirt 314b of the flower pot cover 300b, the sleeve portion 316 will further be provided with a detaching element 318 for detaching the sleeve portion 316 from the skirt 314b of the flower pot cover 300b. When the sleeve portion 316 is removed from the flower pot cover 300b via the detaching element 318, the skirt 314b remains and extends from the base portion 302b of the flower pot cover 300b.

“Detaching element” as used herein means any element, or combination of elements, or features, such as, but not by way of limitation, perforations, tear strips, zippers, and any other devices or elements of this nature known in the art, or any combination thereof. Therefore, while perforations are shown and described herein, it will be understood that tear strips, zippers, or any other “detaching elements” known in the art, or any combination thereof, could be substituted therefor and/or used therewith. In addition, the detaching element 318 may be provided with any configuration, including but not limited to, linear, non-linear, horizontally-extending, vertically-extending, diagonally-extending, scalloped, triangular, and the like.

The flower pot covers 300, 300a and 300b may be formed by any one of numerous methods known in the art, including but not limited to, injection molding, thermoforming, blow molding, vacuum forming, casting, stamping, and various extrusion processes, as well as formed of a ceramic material. Examples of methods of forming the flower pot covers 300, 300a and 300b are disclosed in U.S. Pat. No. 5,706,605, issued to Alcazar et al on Jan. 13, 1998, the contents of which are hereby expressly incorporated herein by reference in their entirety. All of the above processes are well known in the art. Therefore, no additional comments of molding a material and forming the material into the flower pot covers 300, 300a and 300b are deemed necessary in order to teach a person skilled in the art how to manufacture the flower pot covers 300, 300a and 300b.

While the flower pot covers 300, 300a and 300b of FIGS. 28-30 have been described herein for use with a flower pot, it is to be understood that the flower pot covers 300, 300a and 300b may be used without a flower pot, and at least one of a growing medium, a floral grouping, a botanical item and a propagule may be disposed directly therein for use in growing such floral or botanical items.

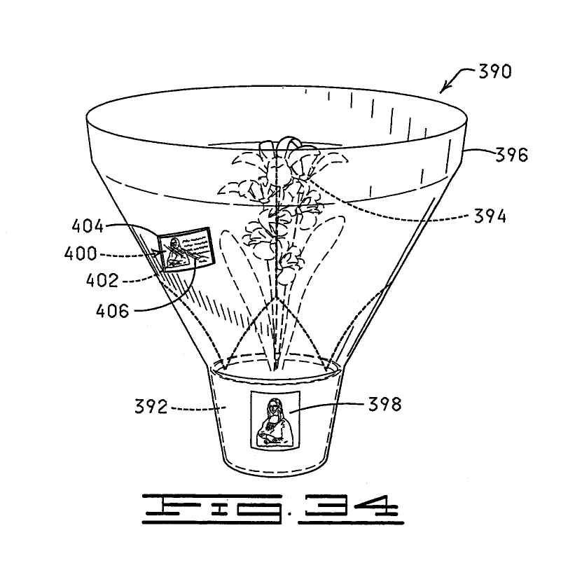

### Description of FIGS. 31-34

FIGS. 31-34 depict another embodiment of the present invention, that is, the combination of a floral package with another decorative item having a graphic image disposed upon a portion thereof, wherein the graphic image is selected from the group consisting of a rendering of at least a portion of a masterpiece work of art, a rendering of at least a portion of a work of art of a Great Master, a rendering of at least a portion of a musical score, and combinations thereof. Examples of items that may be used in accordance with the present invention include, but are not limited to, a floral insert, a floral card, a gift card, an occasion card (including cards that are folded and openable to contain a message inside), a credit-card type card, one or more balloons, a candy wrapper, a bag or other container of candy, a stuffed animal, a small picture frame, other small containers, instructional or advertising material, and the like.

Four specific embodiments are shown in FIGS. 31-34 and will be described herein below; however, it is to be understood that the invention is not limited to the specific embodiments shown herein, and a person of ordinary skill in the art will recognize the value of the combination of floral packaging with a second item as defined herein above, and such combinations also fall within the scope of the present invention.

FIG. 31 depicts a decorative covering or wrapper 330 for a floral grouping 332 formed of a sheet of material, wherein the decorative covering or wrapper 330 is similar to the decorative coverings 58 and 58a described herein above with reference to FIGS. 4-8 and is provided with a graphic image 334 disposed thereon. The decorative wrapper 330 is used in combination with a floral card or floral insert 338. Floral inserts and floral cards are well known in the art, and therefore a description of forming such floral insert or card is not deemed necessary for the scope of the present invention. However, the use of a floral insert or card having a graphic image of a masterpiece work of art thereon in combination with a floral package having a similar or identical graphic image disposed thereon has not been considered before now, and therefore such concept falls within the scope of the present invention. The present invention includes the combination of such a floral insert or card with any of the embodiments described herein.

The floral card or insert 338 is provided with a graphic image 340 disposed thereon. The graphic image 340 of the floral card 338 is identical or similar to the graphic image 334 of the decorative wrapper 330.

The combination is provided with an attaching element 336 for attaching the floral insert or floral card 338 to the decorative wrapper 330 or maintaining the floral insert or card 338 in close proximity to the decorative wrapper 330, thereby providing the combination of the floral insert or floral card 338 and decorative wrapper 330. In FIG. 31, the attaching element 336 is illustrated as being a slot or opening in the decorative wrapper 330 in which the floral insert or card 338 may be inserted; however, the slot or opening is shown for the purpose of illustrating only, and other attaching elements known in the art may be utilized as the attaching element 336. For example, but not by way of limitation, the attaching element 336 may be an adhesive, cohesive or other bonding material disposed on the decorative wrapper 330 and/or the floral insert or card 338; a hole disposed in the decorative wrapper 330 or the floral insert or card 338 and a ribbon, string or other securing element disposed on the other of the decorative wrapper 330 or floral insert or card 338; a floral stick or stem that may be inserted into a retaining space of the decorative wrapper 330 in close association to the floral grouping 332; a slot or pocket having a clear, transparent or translucent outer surface for viewing an item disposed therein, and the like. In another alternative, the floral insert or card 338 may be utilized without an attaching element, and the floral insert or card 338 may simply be placed in a retaining space of the decorative wrapper 330.

Shown in FIG. 32 is a decorative covering 350 for a floral grouping 352 formed of a sleeve 354, wherein the decorative covering 350 is similar to the decorative coverings 84, 84d and 58a described herein above with reference to FIGS. 9-12 and is provided with a graphic image 356 disposed thereon. The decorative covering 350 is used in combination with one or more balloons 360 having a graphic image 362 disposed thereon or visible there through. The graphic image 362 of the at least one balloon 360 is identical to, similar to, or complementary to the graphic image 356 of the sleeve 354. The combination of the decorative covering 350 and the at least one balloon 360 may further be provided with an attaching element 364 that maintains the decorative covering 350 and the at least one balloon 360 in close proximity to one another or attached to one another. For example, in FIG. 32 a string or ribbon is illustrated as the attaching element 364. However, other attaching elements known in the art may be utilized as the attaching element 364, including but not limited to, a straw, a rod, an adhesive, cohesive or other bonding material, a tube, and the like. In another alternative, it may be desired to not utilize an attaching element 364.

Shown in FIG. 33 is a decorative cover 370 for a flower pot 372 having a floral grouping 374 disposed therein, wherein the decorative cover 370 is provided with a graphic image 376 disposed thereon. The decorative cover 370 is similar to the decorative covers 130, 166, 200, 220 and 230 described in detail herein, and the decorative cover 370 may be a preformed flower pot cover or a cover formed by wrapping a sheet of material about the flower pot 372. A floral card 378 having a graphic image 380 disposed thereon is provided, and is attached to or maintained in close proximity to the decorative cover 370. For example but not by way of limitation, the floral card 378 is shown in FIG. 33 as being disposed upon a floral stick or stem 382 that is disposed in the flower pot 372 and held in place by a growing medium 384. The graphic image 380 of the floral card 378 may be identical or similar to the graphic image 376 of the decorative cover 370.

It is to be understood that the decorative cover 370 may be utilized without a flower pot, and at least one of a botanical item, a floral grouping, a propagule, and growing medium may be disposed directly therein.

Shown in FIG. 34 is a decorative cover 390 for a flower pot 392 having a floral grouping 394 disposed therein, wherein the decorative cover 390 is formed of a sleeve 396 and provided with a graphic image 398 disposed thereon. The decorative cover 390 and the sleeve 396 from which the decorative cover is formed are similar to the sleeve 170 and the decorative covering 198 described in detail herein before with reference to FIGS. 21-23. An item 400, such as a gift card, an occasion card or instructional or advertising material, is provided, wherein the item 400 has a graphic image 402 disposed thereon. The item 400 is attached to or maintained in close proximity to the decorative cover 390. For example but not by way of limitation, the decorative cover 390 is illustrated as having a slot or pocket 404 having a clear, transparent or translucent outer surface 406, wherein the item 400 may be at least partially disposed in the slot or pocket 404, and the item 400 is visible through the outer surface 406 of the pocket 404. The graphic image 402 of the item 400 is identical to, similar to, or complementary to the graphic image 398 of the decorative cover 390.

Another embodiment of the present invention also encompasses the use of a graphic image depicting a rendering of a masterpiece work of art or a work of art of a Great Master for floral advertising. This embodiment includes all types of advertising media, including but not limited to, print, television, video, film, digital transmissions, internet, and the like.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A method for decoratively covering a flower pot, comprising the steps of:
providing a preformed flower pot cover having an upper end, a lower end, an outer peripheral surface, a retaining space, and a graphic image which is substantially undistorted and visible on the outer peripheral surface thereof, the graphic image being selected from the group consisting of a rendering of at least a portion of a masterpiece work of art, a rendering of at least a portion of a work of art of a Great Master, a rendering of at least a portion of a musical score and combinations thereof;
providing a flower pot having a lower end and an outer peripheral surface, the flower pot having a floral grouping disposed therein; and
disposing the flower pot in the retaining space of the preformed flower pot cover whereby the graphic image is prominently displayed.

2. The method of claim 1 wherein, in the step of providing the preformed flower pot cover, the preformed flower pot cover is constructed of a material selected from the group consisting of paper, cloth, polymeric film, foil, combinations thereof and laminations thereof.

3. The method of claim 1 wherein, in the step of providing the preformed flower pot cover, the preformed flower pot cover is formed of a material having a thickness in a range of from about 0.1 mil to about 30 mil.

4. The method of claim 1 wherein, in the step of providing the preformed flower pot cover, the preformed flower pot cover is provided with a bonding material disposed on at least a portion of at least one surface thereof, whereby the bonding material pressingly engages the outer peripheral surface of the flower pot to attached the preformed flower pot cover to the flower pot.

5. The method of claim 1 wherein, in the step of providing the preformed flower pot cover, the preformed flower pot cover is initially formed in an opened condition.

6. The method of claim 1 wherein, in the step of providing the preformed flower pot cover, the preformed flower pot cover is further defined as comprising a base portion and a skirt portion.

7. The method of claim 1 wherein, in the step of providing the preformed flower pot cover, the preformed flower pot cover is formed of a shape-sustaining material.

8. The method of claim 7 wherein, in the step of providing the preformed flower pot cover, the preformed flower pot cover is formed of at least one of a rigid material and a semi-rigid material.

9. The method of claim 7 wherein, in the step of providing the preformed flower pot cover, the preformed flower pot cover is formed of a material selected from the group consisting of cardboard, plastic, a thermoplastic material, a thermoset material and combinations thereof.

10. A method for decoratively covering a flower pot, comprising the steps of:
providing a preformed flower pot cover formed of a shape-sustaining material and having an upper end, a lower end, an outer peripheral surface, a retaining space, and a graphic image which is substantially undistorted and visible on the outer peripheral surface thereof, the graphic image being selected from the group consisting of a rendering of at least a portion of a masterpiece work of art, a rendering of at least a portion of a work of art of a Great Master, a rendering of at least a portion of a musical score and combinations thereof;
providing a flower pot having a lower end and an outer peripheral surface, the flower pot having a floral grouping disposed therein; and
disposing the flower pot in the retaining space of the preformed flower pot cover whereby the graphic image is prominently displayed.

11. The method of claim 10 wherein, in the step of providing the preformed flower pot cover, the preformed flower pot cover is provided with a bonding material disposed on at least a portion of at least one surface thereof, whereby the bonding material pressingly engages the outer peripheral surface of the flower pot to attach the preformed flower pot cover to the flower pot.

12. The method of claim 10 wherein, in the step of providing the preformed flower pot cover, the preformed flower pot cover is initially formed in an opened condition.

13. The method of claim 10 wherein, in the step of providing the preformed flower pot cover, the preformed flower pot cover is further defined as comprising a base portion and a skirt portion.

14. The method of claim 10 wherein, in the step of providing the preformed flower pot cover, the preformed flower pot cover is formed of at least one of a rigid material and a semi-rigid material.

15. The method of claim 10 wherein, in the step of providing the preformed flower pot cover, the preformed flower pot cover is formed of a material selected from the group consisting of cardboard, plastic, a thermoplastic material, a thermoset material and combinations thereof.

16. A method for decoratively covering a flower pot, comprising the steps of:
providing a preformed flower pot cover formed of a shape-sustaining material selected from the group consisting of a thermoplastic material, a thermoset material and combinations thereof, the preformed flower pot cover having an upper end, a lower end, an outer peripheral surface, a retaining space, and a graphic image which is substantially undistorted and visible on the outer peripheral surface thereof, the graphic image being selected from the group consisting of a rendering of at least a portion of a masterpiece work of art, a rendering of at least a portion of a work of art of a Great Master, a rendering of at least a portion of a musical score and combinations thereof;
providing a flower pot having a lower end and an outer peripheral surface, the flower pot having a floral grouping disposed therein; and
disposing the flower pot in the retaining space of the preformed flower pot cover whereby the graphic image is prominently displayed.

17. The method of claim 16 wherein, in the step of providing the preformed flower pot cover, the preformed flower pot cover is provided with a bonding material disposed on at least a portion of at least one surface thereof, whereby the bonding material pressingly engages the outer peripheral surface of the flower pot to attach the preformed flower pot cover to the flower pot.

18. The method of claim 16 wherein, in the step of providing the preformed flower pot cover, the preformed flower pot cover is further defined as comprising a base portion and a skirt portion.

19. The method of claim 16 wherein, in the step of providing the preformed flower pot cover, the preformed flower pot cover is formed of at least one of a rigid material and a semi-rigid material.
